(19) United States
(12) Patent Application Publication
(10) Pub. No.: US 2025/0207859 A1
(43) Pub. Date: Jun. 26, 2025

(54) METAL MELTING AND TEMPERATURE-RAISING SUPPLY SYSTEM AND MOLTEN METAL SUPPLY APPARATUS

(71) Applicant: DENSO CORPORATION, Kariya-city (JP)

(72) Inventors: Yasuhito OZEKI, Kariya-city (JP); Yuki KAWABATA, Kariya-city (JP); Takaya INOUE, Kariya-city (JP); Tsuyoshi ARAI, Kariya-city (JP)

(21) Appl. No.: 18/991,812

(22) Filed: Dec. 23, 2024

(30) Foreign Application Priority Data
Dec. 26, 2023 (JP) 2023-219571

(51) Int. Cl. F27B 14/20; F27B 14/06; F27B 14/08

(52) U.S. Cl. CPC F27B 14/20; F27B 14/061; F27B 2014/0843; F27B 2014/0887

(57) ABSTRACT

In a metal melting and temperature-raising supply system, a melting apparatus heats a metal material that is in a solid state and changes the metal material to a molten metal that is in a liquid state. A temperature raising apparatus includes a heat-resistant container that houses the molten metal produced by the melting apparatus and a temperature-raising heating unit that heats the molten metal housed in the heat-resistant container. A molten metal supply apparatus provides the molten metal to an external processing equipment in a state in which a temperature of the molten metal heated by the temperature raising apparatus is maintained. A control apparatus controls an amount of metal material in the solid state changed to the molten metal by the melting apparatus and supplied to the heat-resistant container, based on an amount of molten metal supplied to the external processing equipment from the molten metal supply apparatus.

### CROSS-REFERENCE TO RELATED APPLICATIONS

This application is based on and claims the benefit of priority from Japanese Patent Application No. 2023-219571, filed on Dec. 26, 2023. The entire disclosure of the above application is incorporated herein by reference.

### BACKGROUND

### Technical Field

The present disclosure relates to a metal melting and temperature-raising supply system and a molten metal supply apparatus.

### Related Art

Melting equipment using an induction-heating aluminum melting furnace is known. The melting equipment supplies a raw material for aluminum melting to a crucible in a solid state, such as in the form of a plate-shaped material or a crushed material, and the crucible moves through each station (referred to, hereafter, as “ST”) on a turntable by step feed. Until the crucible reaches a molten metal supply ST from a raw material introducing ST, the crucible is induction-heated by an induction heating coil set on an outer periphery of the crucible. The raw material for aluminum melting is heated and melted by the heat generated in the crucible. Then, the melting equipment tilts the crucible when the crucible reaches the molten metal supply ST and supplies (i.e., pours) the molten metal to an external processing equipment.

### SUMMARY

One aspect of the present disclosure provides a metal melting and temperature-raising supply system that melts a metal material that is in a solid state, raises a temperature of the metal material, and supplies the metal material to an external processing equipment. The metal melting and temperature-raising supply system includes a melting apparatus, a temperature raising apparatus, a molten metal supply apparatus, and a control apparatus. The melting apparatus heats a metal material that is in a solid state and changes the metal material to a molten metal that is in a liquid state. The temperature raising apparatus includes a heat-resistant container that houses the molten metal produced by the melting apparatus and a temperature-raising heating unit that heats the molten metal housed in the heat-resistant container. The molten metal supply apparatus provides the molten metal to an external processing equipment in a state in which a temperature of the molten metal heated by the temperature raising apparatus is maintained. The control apparatus controls an amount of metal material in the solid state changed to the molten metal by the melting apparatus and supplied to the heat-resistant container, based on an amount of molten metal supplied to the external processing equipment from the molten metal supply apparatus.

### BRIEF DESCRIPTION OF THE DRAWINGS

In the accompanying drawings:

FIG. 1 is a planar view of a metal melting and temperature-raising supply system according to an embodiment;

FIG. 2 is a side view of the metal melting and temperature-raising supply system according to the embodiment;

FIG. 3 is a cross-sectional view of a melting apparatus according to the embodiment;

FIG. 4 is a cross-sectional view of the melting apparatus in a variation example according to the embodiment;

FIG. 5 is a planar view of a temperature raising apparatus according to the embodiment;

FIG. 6 is a cross-sectional view of a temperature raising pot provided in the temperature raising apparatus according to the embodiment;

FIG. 7 is an explanatory diagram of a melting ST of the temperature raising apparatus according to the embodiment;

FIG. 8 is an explanatory diagram of a cleaning ST of the temperature raising apparatus according to the embodiment;

FIG. 9 is an explanatory diagram of a foreign matter removing ST of the temperature raising apparatus according to the embodiment;

FIG. 10 is an explanatory diagram of a molten metal supply ST of the temperature raising apparatus according to the embodiment;

FIG. 11 is a cross-sectional view of a molten metal supply apparatus according to the embodiment;

FIG. 12 is an explanatory diagram for explaining operations of the molten metal supply apparatus following FIG. 10;

FIG. 13 is an explanatory diagram for explaining operations of the molten metal supply apparatus following FIG. 12; and

FIG. 14 is an explanatory diagram for explaining operations of the molten metal supply apparatus following FIG. 13.

### DESCRIPTION OF THE EMBODIMENTS

JP 2011-000598 A describes melting equipment using an induction-heating aluminum melting furnace. The melting equipment supplies a raw material for aluminum melting to a crucible in a solid state, such as in the form of a plate-shaped material or a crushed material, and the crucible moves through each station (referred to, hereafter, as “ST”) on a turntable by step feed. Until the crucible reaches a molten metal supply ST from a raw material introducing ST, the crucible is induction-heated by an induction heating coil set on an outer periphery of the crucible. The raw material for aluminum melting is heated and melted by the heat generated in the crucible. Then, the melting equipment tilts the crucible when the crucible reaches the molten metal supply ST and supplies (i.e., pours) the molten metal to an external processing equipment.

However, the melting equipment in JP 2011-000598 A has the following issues regarding an amount, a temperature, and purity of the molten metal supplied to the external processing equipment.

First, regarding the amount of molten metal, the melting equipment supplies the raw material for aluminum melting to the crucible in a solid state, such as in the form of a plate-shaped material or a crushed material. Accuracy of the amount of molten metal inside the crucible is dependent on the form of the material that is introduced. Therefore, in the melting equipment, variations in the amount of molten metal inside the crucible occur in units of weight per plate-shaped material or crushed material that is introduced. Consequently, an issue arises in the melting equipment in that, when the crucible is tilted and the molten metal is supplied to the external processing equipment, variations occur in the amount of molten metal supplied to the external processing equipment.

Next, regarding the temperature of the molten metal, the melting equipment melts and raises the temperature of the metal in a solid-liquid coexistent state inside the crucible.

Therefore, the temperature of the molten metal while the temperature is being raised varies depending on a solid-liquid coexistence balance that changes with the shape of the material introduced into the crucible and an attitude of the material when being introduced. Therefore, in the melting equipment, although temperature adjustment through control of induction-heating output just before completion of melting is performed to bring the molten metal to a target temperature, because the crucible is operated by step feed, a mechanism to independently control output is required for all induction-heating coils at the stations. This leads to an increase in equipment cost. Furthermore, because temperature adjustment is performed immediately before the molten metal is supplied, when a molten metal supply cycle is short, an amount of time during which temperature adjustment can be performed is short. Therefore, a range over which variations can be made is limited. Even when temperature adjustment is made, because the molten metal is supplied by the crucible being tilted, an amount of time over which the molten metal is exposed to atmospheric air is long. An issue arises in that the temperature of the molten metal while the molten metal is being supplied also becomes unstable.

Next, regarding purity of the molten metal, the melting equipment performs a gas releasing process to release gas components dissolved in the molten metal at a gas releasing ST provided between the raw material introducing ST and the molten metal supply ST. However, in the melting equipment, the amount, the temperature, and the solid-liquid coexistence balance of the molten metal inside the crucible changes every time. Therefore, an issue arises in that a degassing effect achieved by the gas releasing process is inconsistent.

When variations occur in molten metal quality such as the amount, the temperature, and the purity of the molten metal supplied to the external processing equipment as described above, variations in quality (such as changes in dimensional accuracy and internal quality, and presence/absence of flash formation) occur in cast products processed by a die casting machine that serves as an example of the external processing equipment. Therefore, an inefficient process design is made as a result of production planning that takes into consideration defect rates and an increase in post-processing finishing measures.

It is thus desired to provide a metal melting and temperature-raising supply system and a molten metal supply apparatus that are capable of supplying molten metal that is high in quality in terms of amount, temperature, and purity to an external processing equipment.

One exemplary embodiment of the present disclosure provides a metal melting and temperature-raising supply system that melts a metal material that is in a solid state, raises a temperature of the metal material, and supplies the metal material to an external processing equipment. The metal melting and temperature-raising supply system includes a temperature raising apparatus, a molten metal supply apparatus, and a control apparatus. The melting apparatus heats the metal material and changes the metal material to a molten metal that is in a liquid state. The temperature raising apparatus includes a heat-resistant container that houses the molten metal produced by the melting apparatus and a temperature-raising heating unit that heats the molten metal housed in the heat-resistant container. The molten metal supply apparatus supplies the molten metal to the external processing equipment in a state in which a temperature of the molten metal heated by the temperature-raising heating apparatus is maintained. The control apparatus controls an amount of metal material in the solid state changed to the molten metal by the melting apparatus and supplied to the heat-resistant container, based on an amount of molten metal supplied to the external processing equipment from the molten metal supply apparatus.

According to the exemplary embodiment, the metal melting and temperature-raising supply system (referred to, hereafter, as a “present system”) changes the metal material in the solid state to the molten material in the liquid state by the melting apparatus and supplies the molten metal to the heat-resistant container. Therefore, the molten metal can be supplied at a fixed amount and a fixed temperature from the melting apparatus to the heat-resistant container. Consequently, because the temperature-raising heating unit can raise the temperature of the molten metal inside the heat-resistant container with a fixed amount of heating energy, equipment cost can be reduced compared to when heating energy of the temperature-raising heating units respectively provided in a plurality of heat-resistant containers is individually output-controlled. In addition, because the amount and the temperature of the molten metal inside the heat-resistant container are fixed, steps of a cleaning process can be shared and a degree of purity of the molten metal can be kept consistent. Therefore, the present system can supply the molten metal that is high in quality in terms of having a target fixed amount, a target fixed temperature, and target fixed purity to the external processing equipment from the heat-resistant container through the molten metal supply apparatus. Consequently, variations in quality such as changes in dimensional accuracy and internal quality, and presence/absence of flash formation can be reduced in cast products processed by the external processing equipment. A lean processing design can be actualized with regard to production design taking into consideration defect rates, post-processing finishing, and the like.

In addition, the present system produces the molten metal at a required amount at a required time in the melting apparatus, raises the temperature of the molten metal in the heat-resistant container, and supplies the molten metal to the external processing equipment, without requiring a large amount of molten metal to be held while being heat-retained at all times. Consequently, the present system can contribute to carbon neutrality and further contribute to safety at a manufacturing site.

Here, in the present disclosure, the fixed amount refers to an amount within a predetermined range having little variation. The fixed temperature refers to a temperature within a predetermined range having little variation. The fixed purity refers to purity within a predetermined range having little variation. The fixed heating energy refers to heating energy within a predetermined range having little variation.

Another exemplary embodiment of the present disclosure provides a molten metal supply apparatus that supplies a molten metal obtained by melting a metal material to an external processing equipment includes: a molten metal supply container to which the molten metal is removed from a heat-resistant container that houses the molten metal, and held in a sealed space; a weight measuring unit that measures weight of the molten metal supply container in three axial directions in an orthogonal coordinate system set in the molten metal supply container, and a control apparatus that calculates an amount of molten metal removed from the heat-resistant container to the molten metal supply container, based on a difference between the weight of the molten metal supply container measured by the weight measuring unit before the molten metal is removed from the heat-resistant container to the molten metal supply container and the weight of the molten metal supply container measured by the weight measuring unit after the molten metal is removed from the heat-resistant container to the molten metal supply container.

According to the exemplary embodiment, the control apparatus calculates the amount of molten metal removed from the heat-resistant container to the molten metal supply container based on a difference in weight of the molten metal supply container. Thus, even when metal residue remains in the bottom of the molten metal supply container due to bonding or the like, a target amount of molten metal can be removed from the heat-resistant container to the molten metal supply container. Consequently, the molten metal supply apparatus can supply the target amount of molten metal from the molten metal supply container to the external processing equipment.

Furthermore, the molten metal supply apparatus uses the weight measuring unit that measures the weight of the molten metal supply container in three axial directions. Thus, the target amount of molten metal can be removed from from the heat-resistant container to the molten metal supply container, even when the molten metal supply apparatus is tilted in relation to the vertical direction. The molten metal supply apparatus can therefore supply the target quantity of molten metal from the molten metal supply container to the external processing equipment.

Here, reference numbers in parentheses attached to constituent elements and the like indicate examples of corresponding relationships between the constituent elements and the like and specific constituent elements and the like described according to embodiments below.

A metal melting and temperature-raising supply system (referred to, hereafter, as a “present system”) according to an embodiment of the present disclosure will hereinafter be described with reference to the drawings.

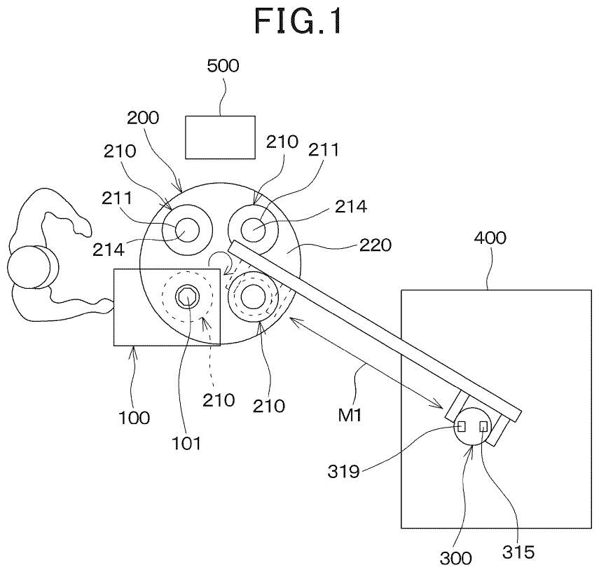

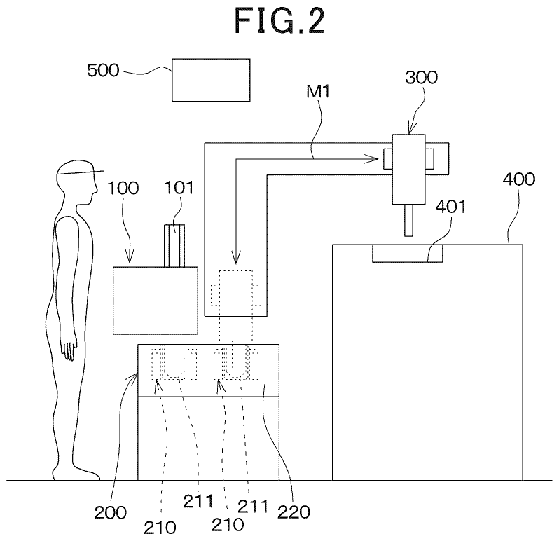

As shown in FIG. 1 and FIG. 2, the present system adjusts a temperature of and measures a molten metal 214, and supplies the molten metal 214 to an external processing equipment 400 such as a die casting machine. The molten metal 214 is obtained by a metal material 101 (such as aluminum or an aluminum alloy) in a solid state being melted and raised in temperature.

The present system includes a melting apparatus 100, a temperature raising apparatus 200, a molten metal supply apparatus 300, a control apparatus 500, and the like. The melting apparatus 100 heats the metal material 101 in the solid state using induction heating and changes the metal material 101 to the molten metal 214 in a liquid state. The temperature raising apparatus 200 receives the molten metal 214 supplied from the melting apparatus 100 in a crucible 211 and successively heats the molten metal 214 to a target temperature. Here, the crucible 211 is an example of a heat-resistant container. The molten metal supply apparatus 300 removes the molten metal 214 heated by the temperature raising apparatus 200 from the crucible 211, retains heat and measures the molten metal 214 in a sealed space, and supplies the molten metal 214 to the external processing equipment 400. The control apparatus 500 is a control board configured by a microcomputer and peripheral circuits thereof. The microcomputer includes a processor such as a central processing unit (CPU), and a memory such as a read-only memory (ROM), a random access memory (RAM), or a flash memory. The control apparatus 500 controls driving of each section of the melting apparatus 100, the temperature raising apparatus 200, and the molten metal supply apparatus 300 by the processor running a program stored in the memory.

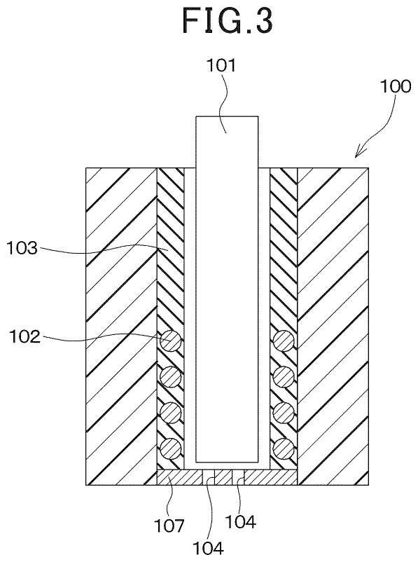

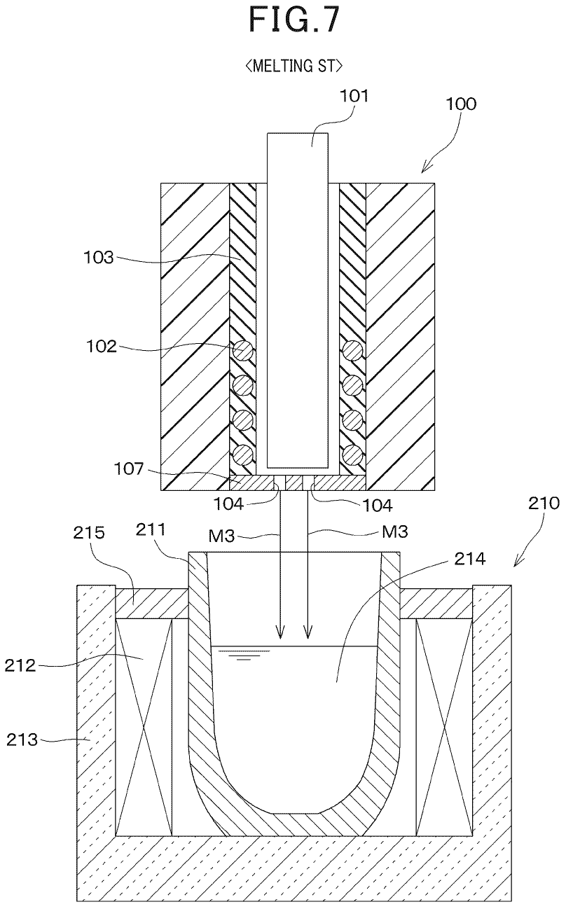

As shown in FIG. 3, the melting apparatus 100 has an induction heating coil 102 that serves as an induction heating unit, a heat-resistant insulating portion 103 that supports the induction heating coil 102, a material receiving portion 107 that is provided below the induction heating coil 102, and the like. For example, the induction heating coil 102 is configured by a coil wire that is wound in a concentric manner. The induction heating coil 102 is capable of heating the metal material 101 placed on an inner circumference side thereof by electromagnetic induction. The material receiving portion 107 has a molten metal through hole 104 that is formed by the induction heating coil 102 and allows the molten metal 214 to pass. As indicated by arrow M3 in FIG. 7, the melting apparatus 100 is capable of changing the metal material 101 in the solid state to the molten metal 214 and directly supplying the molten metal 214 to the crucible 211 from the molten metal through hole 104.

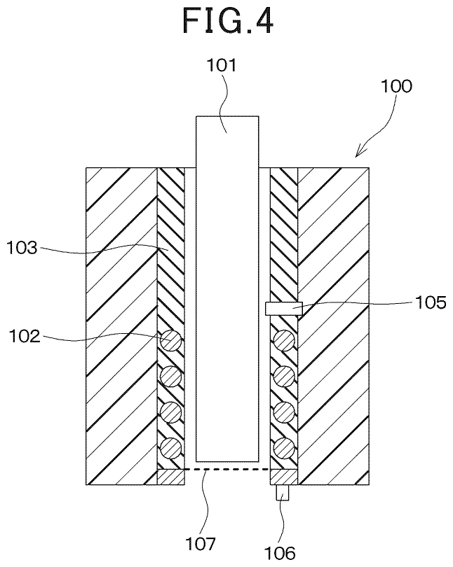

In addition, as a variation example according to the embodiment, as shown in FIG. 4, the melting apparatus 100 may have a material detecting unit 105 that detects presence/absence of the metal material 101 and a molten-metal surface detecting unit 106 that detects a molten-metal surface height of the molten metal 214 housed in the crucible 211. The molten-metal surface detecting unit 106 is an example of a molten-metal amount detecting unit that detects an amount of the molten metal 214 housed in the crucible 211. For example, the molten-metal surface detecting unit 106 is configured by a laser sensor or a camera. In addition, the material receiving portion 107 may be configured by a wire netting or the like.

The metal material 101 such as a metal ingot that serves as a raw material for the molten metal 214 is introduced on the inner circumference side of the induction heating coil 102 so that an attitude of the metal material 101 is set. The metal material 101 may be manually introduced. Alternatively, the material detecting unit 105 may be provided as shown in FIG. 4 and the metal material 101 may be automatically introduced depending on decrease in the metal material 101. When alternating-current power is supplied to the induction heating coil 102 from a high-frequency, alternating-current power supply, the metal material 101 generates Joule heat. As a result of the metal material 101 exceeding a melting point thereof, the metal material 101 changes phase from solid to liquid. The molten metal 214 then drains into the crucible 211 through the molten metal through hole 104. The induction heating coil 102 is preferably covered by the heat-resistant insulating portion 103 that covers the overall coil for increased safety. The induction heating coil 102 is not necessarily required to have a concentric configuration. Heating efficiency can be improved by the induction heating coil 102 being optimally designed based on a shape of a material to be used.

At a start of continuous startup of the overall present system, time is required for the metal material 101 to start melting from room temperature. Therefore, correlation data between induction heating output and temperature of the metal material 101 is acquired in advance for each metal material 101 to be used. A preheating function to raise and maintain the temperature to just before the temperature at which the metal material 101 melts when the present system is started is provided. A correlation between a melting amount and the induction heating output during melting is also acquired. As a result of switching being performed between melting output set based on a required melting amount and cycle time, and preheating output for preheating, a fixed amount of molten metal 214 is supplied to the crucible 211 below at a target cycle time. Regarding switching of output, first, preheating is performed during operation preparation. After completion of preheating, an operation preparation completed signal is sent to the control apparatus 500 of the overall present system. Based on a co-operation start signal from overall control, preheating output is switched to melting output and melting is started. The output may be automatically switched to preheating output at a time based on the correlation between the melting amount and the induction heating output, described above. Alternatively, as shown in FIG. 4, the molten-metal surface detecting unit 106 may be provided in the melting apparatus 100. The molten-metal surface detecting unit 106 may sense the molten-metal surface height of the molten metal 214 inside the crucible 211, and switching from the induction heating output may be performed based on the molten-metal surface height. At a second and subsequent cycle of the crucible 211, an actual amount of the molten metal 214 supplied from the crucible 211 to the external processing equipment 400 may be fed back to the molten metal supply apparatus 300, described hereafter. Switching from the induction heating output may be performed after an amount equivalent to the feedback amount is melted again.

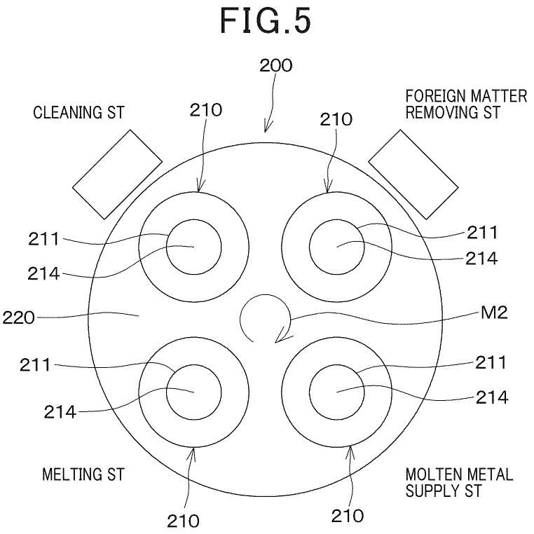

As shown in FIG. 5, the temperature raising apparatus 200 has a plurality of stations (referred to, hereafter, as ST). Specifically, the temperature raising apparatus 200 has a melting ST that receives the molten metal 214 supplied from the melting apparatus 100, a cleaning ST that supplies inert gas to the molten metal 214, a foreign matter removing ST that removes foreign matter 231 that floats on the molten metal surface as a result of cleaning, and a molten metal supply ST that supplies the molten metal 214 to the outside. Temperature raising pots 210 are set in a fixed manner at even intervals on a circular circumference of a turning stand 220. The turning stand 220 is step-fed in steps at a predetermined time interval by 1/number of ST of a single rotation (360°) by a rotation driving apparatus (not shown). An arrow M2 in FIG. 5 indicates a step-feed direction of the turning stand 220. FIG. 5 shows an example in which four STs are present. However, through optimal design of the number of STs based on the required melting amount and cycle time, variations can be accommodated.

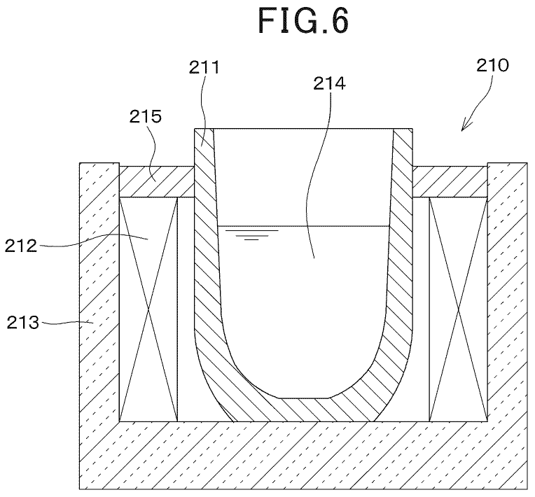

As shown in FIG. 6, each of the plurality of temperature raising pots 210 has the crucible 211 that receives the molten metal 214, a temperature-raising heating unit 212 that heats the crucible 211 from the outside, and a temperature raising pot thermal insulation wall 213 that suppresses heat dissipation from the temperature-raising heating unit 212 to the outside. The crucible 211 is a heat-resistant container that houses the molten metal 214 produced by the melting apparatus 100. The temperature-raising heating unit 212 is, for example, a radiant heater, and heats and raises the temperature of the molten metal 214 housed in the crucible 211. The plurality of temperature-raising heating units 212 are respectively provided in the plurality of crucibles 211. Degradation over time can be expected to occur in the crucible 211 due to contact with the high-temperature molten metal 214. Therefore, a structure that allows the crucible 211 to be easily replaced is provided by an outer diameter of the crucible 211 being set to be equal to or less than an inner diameter of a positioning portion 215 of the temperature-raising heating unit 212.

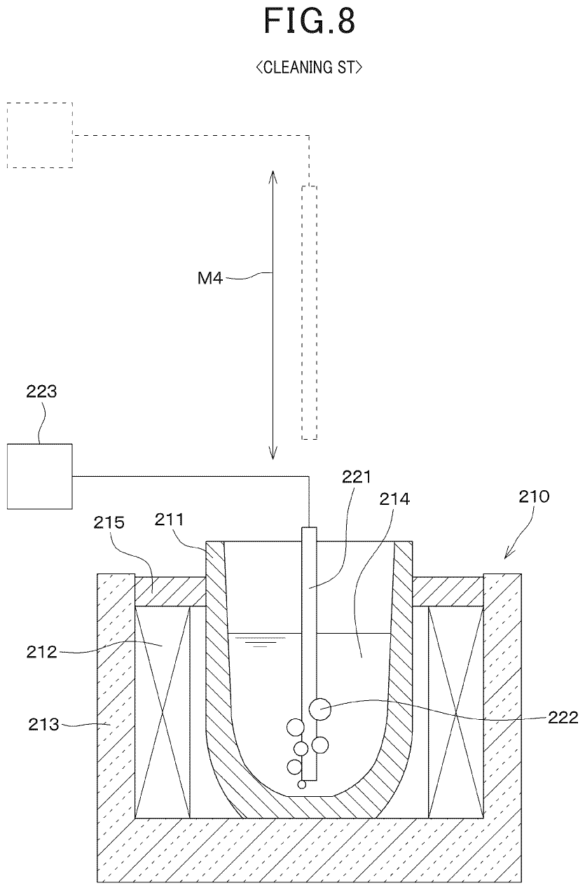

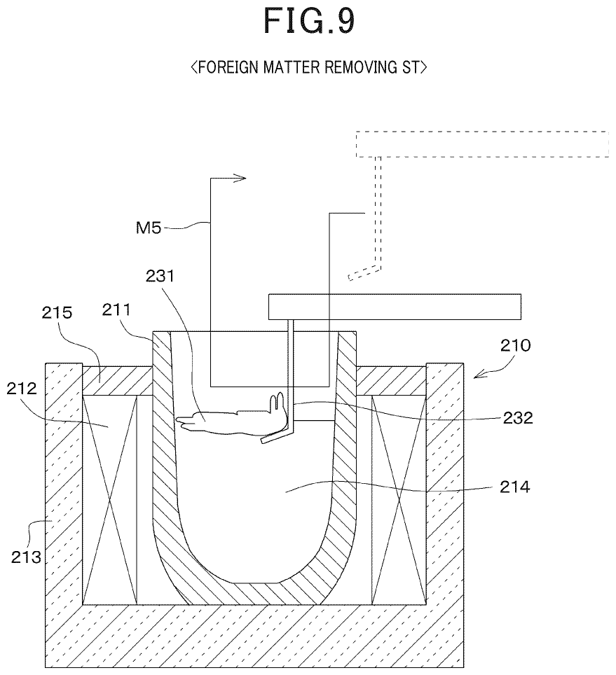

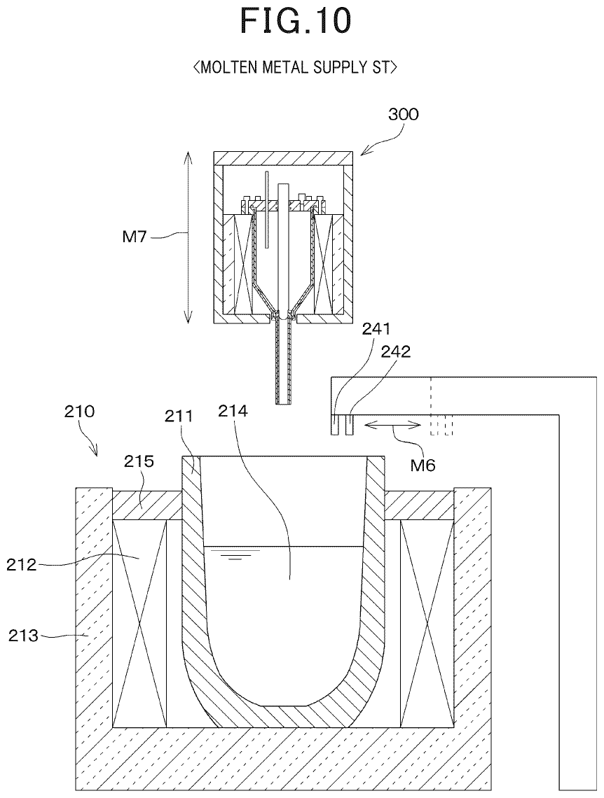

As shown in FIG. 8, a gas pipe 221 that sends inert gas 222 into the molten metal 214 to clean the molten metal 214 is provided at the cleaning ST that serves as a cleaning processing unit. As shown in FIG. 9, a scraper 232 that scrapes and removes foreign matter 231 that floats near the molten metal surface at the cleaning ST is provided at the foreign matter removing ST. As shown in FIG. 10, a molten metal supply ST molten-metal surface detecting unit 241 that detects the molten metal surface of the molten metal 214 housed in the crucible 211 and a molten-metal temperature confirming unit 242 that confirms the temperature of the molten metal with contact or without contact are provided at the molten metal supply ST. The molten metal supply ST molten-metal surface detecting unit 241 and the molten metal temperature confirming unit 242 can be moved to a position facing the molten metal 214 housed in the crucible 211 and a position away from the crucible 211 as indicated by arrow M6. In addition, the molten metal supply apparatus 300 can be moved to a position away from the crucible 211 and a position near the crucible 211 as indicated by arrow M7.

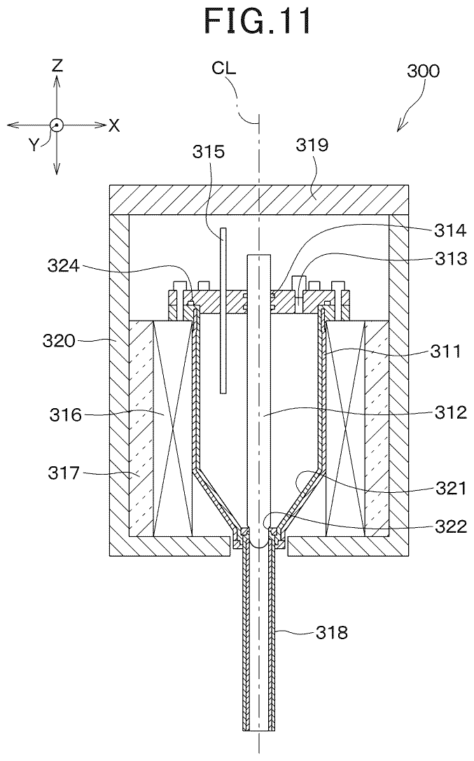

As shown in FIG. 11, the molten metal supply apparatus 300 includes a molten metal supply pot 311 that serves as a molten metal supply container, a suction pipe 318, a shutoff pin 312, a vacuum suction and inert gas supply opening 313, seal portions 314 and 324, a molten-metal temperature detecting unit 315, a molten metal supply heating unit 316, a thermal insulation wall 317, a weight measuring unit 319, and a casing 320. The molten metal supply pot 311 is a container to which the molten metal 214 from the crucible 211 is removed and holds the molten metal 214 in a sealed space. A bottom inner wall 321 of the molten metal supply pot 311 has a tapered shape at an angle exceeding 0° in relation to a virtual plane perpendicular to an axis CL of the molten metal supply pot 311. The suction pipe 318 is a pipe that extends downward from the bottom of the molten metal supply pot 311. The shutoff pin 312 is a member that opens and closes a molten metal opening 322 provided in the bottom of the molten metal supply pot 311. The vacuum suction and inert gas supply opening 313 is an opening portion for vacuum suctioning when the molten metal 214 is suctioned from the crucible 211 into the molten metal supply pot 311, and for supplying inert gas when the molten metal 214 is supplied from the molten metal supply pot 311 to the external processing equipment 400. The seal portions 314 and 324 are elastic members that prevent gas from entering into and exiting from the molten metal crucible 511 from a structure attaching portion. The molten-metal temperature detecting unit 315 is a temperature sensor that detects a temperature (that is, molten metal temperature) of the molten metal 214 suctioned and held in the molten metal supply pot 311. The molten metal supply heating unit 316 is a heater apparatus that heats the molten metal 214 held in the molten metal supply pot 311. The thermal insulation wall 317 is configured by a material that has lower thermal conductivity than the molten metal supply pot 311. The thermal insulation wall 317 is provided on an outer side of the molten metal supply pot 311 and suppresses heat dissipation of the molten metal 214 held in the molten metal supply pot 311. The weight measuring unit 319 is a sensor that measures a weight of the overall molten metal supply apparatus 300. The casing 320 is a member that packages the sections of the molten metal apparatus 300.

The weight measuring unit 319 is capable of measuring the weight of the overall molten metal supply apparatus 300 including the molten metal supply pot 311 in three axial directions of an orthogonal coordinate system set in the molten metal supply pot 311. Here, the three axial directions in the orthogonal coordinate system set in the molten metal supply pot 311 are directions in which an X axis, a Y axis, and a Z axis respectively extend in an orthogonal coordinate system in which the axis CL of the molten metal supply pot 311 is the Z axis, and two axes that are orthogonal on a plane perpendicular to the Z axis are the X axis and the Y axis. For example, the weight measuring unit 319 is configured by a plurality of load sensors that respectively measure load in the X-axis direction, load in the Y-axis direction, and load in the Z-axis direction.

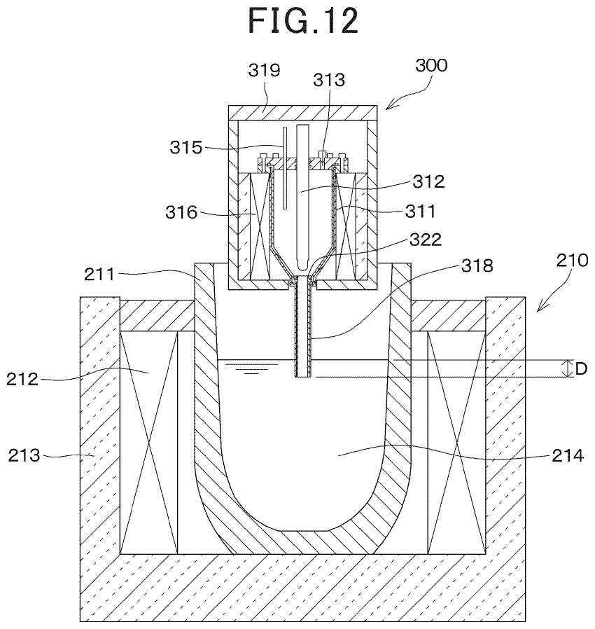

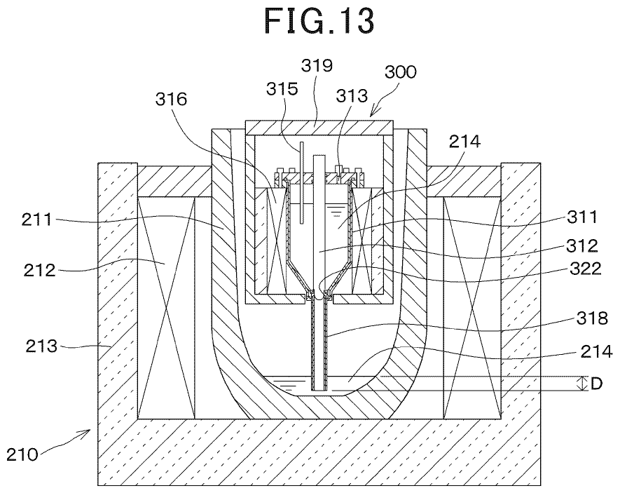

Based on molten metal supply instructions, as shown in FIG. 12, the molten metal supply apparatus 300 immerses a tip end portion of the suction pipe 318 in the molten metal 214 from the molten metal surface measured by the molten metal supply ST molten-metal surface detecting unit 241 to an immersion depth D that is determined in advance. After immersion, an interior of the molten metal supply pot 311 is placed in a vacuum state by a vacuum suction mechanism (not shown) that is connected to the vacuum suction and inert gas supply opening 313 being driven. The molten metal 214 inside the crucible 211 is then suctioned into the molten metal supply pot 311. The control apparatus 500 controls a suctioned amount based on a negative pressure profile that is acquired in advance for the purpose of preventing overshooting of suction before the molten metal 214 is suctioned to a prescribed amount. As shown in FIG. 13, when the molten metal 214 suctioned into the molten metal supply pot 311 reaches the prescribed suctioned amount, the shutoff pin 312 is dropped to come into contact with an upper end (that is, an inner edge of the molten metal opening 322) of the suction pipe 318, and the molten metal opening 322 is held closed. Heat of the molten metal 214 is retained so that the target temperature can be maintained by the molten metal supply heating unit 316, while the temperature of the molten metal 214 is managed at a stage in which the suctioned molten metal 214 is in contact with the molten-metal temperature detecting unit 315. As indicated by arrow M1 in FIG. 1 and FIG. 2, the molten metal supply apparatus 300 moves to a molten metal supply position 401 of the external processing equipment 400 in a state in which the molten metal 214 is held and heat-retained. Then, the shutoff pin 312 is raised and the molten metal opening 322 is opened. In addition, inert gas is supplied from the vacuum suction and inert gas supply opening 313 into the molten metal supply pot 311. The molten metal 214 is thereby supplied to the external processing equipment 400.

As shown in FIG. 12 and FIG. 13, the immersion depth D of the suction pipe 318 when the molten metal 214 inside the crucible 211 described above is vacuum-suctioned into the molten metal supply pot 311 is not limited. However, the immersion depth D is preferably about 5 mm to 20 mm from the molten metal surface. As a result, oxides on the molten metal surface can be prevented from being suctioned. In addition, an amount of molten metal 214 attached to the outer side of the suction pipe 318 can be reduced. Here, the immersion depth D of the suction pipe 318 is not limited thereto. For example, the suction pipe 318 may be immersed in the molten metal 214 inside the crucible 211 to a depth that enables suction of the molten metal 214 at a target amount to be removed from the crucible 211 to the molten metal supply pot 311.

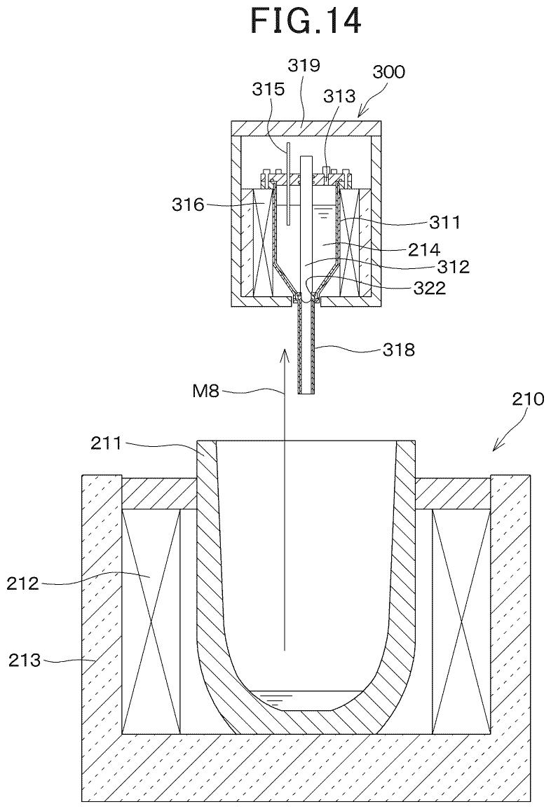

As shown in FIG. 10 and FIG. 14, when the molten metal 214 inside the crucible 211 is vacuum-suctioned into the molten metal supply pot 311, the control apparatus 500 measures, by the weight measuring unit 319, a weight before the suction pipe 318 is immersed in the molten metal 214 at the start of suction and a weight when the suction pipe 318 is in a fully raised position from the crucible 211 after completion of suction, and sets a difference in weight as an actual suctioned amount. That is, the control apparatus 500 calculates the amount of the molten metal 214 removed from the crucible 211 to the molten metal supply pot 311 based on the weight measured by the weight measuring unit 319 before the molten metal 214 is removed from the crucible 211 to the molten metal supply pot 311 and the weight measured by the weight measuring unit 319 after the molten metal 214 is removed from the crucible 211 to the molten metal supply pot 311.

In addition, as shown in FIG. 12 and FIG. 13, when the molten metal 214 in the crucible 211 is vacuum-suctioned into the molten metal supply pot 311, the control apparatus 500 continuously measures the weight by the weight measuring unit 319 even when the molten metal 214 in the crucible 211 in which the suction pipe 318 is immersed in the molten metal 214 is vacuum-suctioned into the molten metal supply pot 311. In addition, when the amount of molten metal 214 suctioned into the molten metal supply pot 311 reaches the target prescribed suctioned amount based on a measurement value of the weight measuring unit 319, the shutoff pin 312 is dropped so as to come into contact with the upper end (that is, the inner edge of the molten metal opening 322) of the suction pipe 318 and the molten metal opening 322 is closed. At this time, a target value of the suctioned amount is calculated taking into consideration buoyant force applied to the molten metal supply apparatus 300 upon completion of immersion and the amount of molten metal 214 returning into the crucible 211 from inside the suction pipe 318 when the molten metal supply apparatus 300 is raised from the crucible 211. Therefore, although the shape of the suction pipe 318 is not limited, suction accuracy is preferably secured by an internal volume of the suction pipe 318 being minimized by an overall length in an up/down direction being shortened or the like. As a result of the suctioned amount being determined from the weight before and after suction taking into consideration external disturbance in this manner, the suctioned amount is fixed even when metal residue is formed over time inside the molten metal supply pot 311.

Here, in general, a method for measuring the amount of molten metal 214 by weight may decrease in accuracy due to tilting of the molten metal supply apparatus 300. In this regard, as a result of the molten metal supply apparatus 300 calculating a total weight based on weight measured at a total of three axes by adding the two axes, the X axis and the Y axis, in addition to the Z axis-direction described above, a high accuracy (such as a variation range of ±1% or less) can be maintained even without the molten metal supply apparatus 300 keeping an upright attitude in relation to the vertical direction.

Next, an overall operation of the present system will be described. As the operation of the present system, as a result of the start of continuous startup in the overall present system, as shown in FIG. 7, a fixed amount of molten metal 214 is supplied from the melting apparatus 100 to the crucible 211 at the melting ST. In the temperature raising apparatus 200, the output of the temperature-raising heating unit 212 is set to an output that enables the target temperature of the molten metal 214 to be reached when the molten metal 214 is supplied at the molten metal supply ST, taking into consideration the amount of molten metal 214 and the cycle time. The crucible 211 is heated at a fixed output at all times, and as a result of heat transfer from the crucible 211, the molten metal 214 is raised in temperature. That is, the temperature starts to rise simultaneously with the molten metal 214 supplied from the melting apparatus 100 being received in the crucible 211. Aside from abnormalities such as temporarily halting, heating is continued until the molten metal 214 is supplied from the crucible 211 at the molten metal supply ST. Because a fixed amount of heating energy is applied to a fixed amount of molten metal 214, the temperature of the molten metal 214 that is produced is also fixed (for example, a variation range of ±1% or less). A melting completed signal is sent to the control apparatus 500 simultaneously with the output being switched to preheating output after the prescribed amount is melted by the melting apparatus 100. A one-step feed signal is transmitted to the turning stand 220 in response, and the temperature raising pot 210 at the melting ST is sent to the cleaning ST.

As shown in FIG. 8, the gas pipe 221 that sends the inert gas 222 into the molten metal 214 to clean the molten metal 214 is provided at the cleaning ST. As a result of a step feed completed signal from the temperature raising pot 210, a supply valve (not shown) of an inert gas supplying apparatus 223 is opened and the supply of inert gas 222 is started. In addition, as indicated by arrow M4, by a vertical mechanism (not shown), the gas pipe 221 is immersed in the molten metal 214. A position to which the gas pipe 221 is immersed is not uniformly determined and can be optimally set based on material type and shape of the crucible 211. However, a position that is near a bottom surface of the crucible 211 but not in contact with the crucible 211 is generally preferred. Here, the position to which the gas pipe 221 is immersed can be an arbitrary position between a center in a depth direction of the molten metal 214 inside the crucible 211 and the bottom inner wall of the crucible 211. A shape of a gas supply hole of the gas pipe 221 and the like, and a supply flow amount and supply time of the inert gas 222 can be determined in advance based on a desired degree of purity of the molten metal 214 and the cycle time. Cleaning can be performed based on these conditions. As a result of a cleaning completed signal, the gas pipe 221 is raised to an original position by the same vertical mechanism. As a result of a raising completed signal thereof, the same supply valve is closed. As a result of the melting completed signal at the melting ST and a gas supply valve closed signal, the temperature raising pot 210 that is at the cleaning ST is sent to the foreign matter removing ST.

As shown in FIG. 9, the scraper 232 that scrapes and removes foreign matter 231 floating near the molten metal surface as a result of cleaning is provided at the foreign matter removing ST. As a result of a step feed completed signal for the temperature raising pot 210, as indicated by arrow M5, the scraper 232 is immersed to a depth set in advance from the molten metal surface by a conveyance mechanism (not shown), and the foreign matter 231 near the molten metal surface is separated and removed from the molten metal 214 by a skimming operation. Here, the method of separating and removing the foreign matter 231 is not limited to the method shown in FIG. 9. For example, a method in which the foreign matter 231 is suctioned can also be considered. The foreign matter 231 that is attached to the scraper 232 is physically removed using a tool or air inside a foreign matter recovery box (not shown). As a result of the melting completed signal at the melting ST, the gas supply valve closed signal at the cleaning ST, and a foreign matter recovery box return signal for the scraper 232 at the foreign matter removing ST, the temperature raising pot 210 that is at the foreign matter removing ST is sent to the molten metal supply ST.

As shown in FIG. 10, at the molten metal supply ST, the molten metal supply ST molten-metal surface detecting unit 241 that detects the surface of the molten metal 214 inside the crucible 211 sent to the molten metal supply ST and the molten-metal temperature confirming unit 242 that confirms whether or not a temperature-raising defect such as heater disconnection has occurred during temperature raising from the melting ST to the molten metal supply ST are provided. In the control apparatus 500, as a result of the step feed completed signal for the temperature raising pot 210, the molten metal supply ST molten-metal surface detecting unit 241 and the molten-metal temperature confirming unit 242 access an area above the molten metal surface, and perform molten-metal surface height measurement and confirm the presence/absence of a temperature raising defect using a temperature of the molten metal 214 set in advance as a determination value.

As shown in FIG. 12, as a result of completion of the molten-metal surface height measurement and molten-metal temperature confirmation, the control apparatus 500 immerses the suction pipe 318 provided in the molten metal supply apparatus 300 in the molten metal 214 to a position determined in advance in relation to the molten-metal surface height measured by the molten metal supply ST molten-metal surface detecting unit 241. The molten metal apparatus 300 suctions and holds the molten metal 214 inside the sealed space of the molten metal supply pot 311 while maintaining heat and measuring the molten metal 214. Then, as shown in FIG. 13, when the molten metal 214 suctioned into the molten metal supply pot 311 reaches the target prescribed suctioned amount, the molten metal supply apparatus 300 drops the shutoff pin 312 to come into contact with the inner edge of the molten metal opening 322, and closes and holds the molten metal opening 322. Next, the molten metal supply apparatus 300 is raised from the crucible 211 as indicated by arrow M8 in FIG. 14. Subsequently, as indicated by arrow Ml in FIG. 1 and FIG. 2, the molten metal supply apparatus 300 is moved to the molten metal supply position, and a fixed amount of the molten metal 214 is supplied to the external processing equipment 400 while maintaining a fixed temperature.

Here, conventionally, in a process such as die casting in which the molten metal 214 is handled, in general, a melting and holding furnace is required to hold (maintain the temperature of) a large amount of molten metal at all times using a gas burner or the like. Therefore, continuous operation is fundamental. Consequently, an amount of energy consumption is needlessly large, and dangerous work in which a worker comes into contact with high temperature objects is required as work for maintaining and retaining the molten metal. In contrast, in the present system, as a result of the molten metal 214 being successively supplied to the external processing equipment 400 at a required amount at a required time, the molten metal 214 can be completely used without being held. Therefore, the present system can contribute to carbon neutrality and improved safety in production. In addition, the present system can supply, to processing equipment, the molten metal 214 that has a fixed target quality (that is, a fixed amount, a fixed temperature, fixed purity) at all times per operation cycle of the system. For example, in aluminum die casting, variations in the quality of the molten metal 214 described above lead to variations in the quality of cast products (that is, changes in dimensional accuracy and internal quality, and presence/absence of flash formation). Therefore, conventionally, production planning that takes into consideration defect rates and an increase in post-processing finishing measures were implemented in response. In this regard, the present system is capable of actualizing a lean processing design by improving robustness of the quality of cast products.

The present system according to the embodiment achieves the following working effects, in relation to the above-described conventional technology and technology described in JP 2011-000598 A.

(1) The present system includes the melting apparatus 100, the temperature raising apparatus 200, the molten metal supply apparatus 300, and the control apparatus 500. The melting apparatus 100 heats the metal material 101 that is in a solid state and changes the metal material 101 into the molten metal 214. The temperature raising apparatus 200 has the crucible 211 that houses the molten metal 214 produced by the melting apparatus 100 and the temperature-raising heating unit 212 that heats the molten metal 214 housed in the crucible 211. The molten metal supply apparatus 300 supplies the molten metal 214 to the external processing equipment 400 in a state in which the temperature of the molten metal 214 heated by the temperature raising apparatus 200 is maintained. The control apparatus 500 performs control based on the amount of the solid-state metal material 101 that is changed into the molten metal 214 and supplied to the crucible 211 by the melting apparatus 100, and the amount of the molten metal 214 that is supplied from the molten metal supply apparatus 300 to the external processing equipment 400.

As a result, the present system changes the metal material 101 that is in the solid state into the molten metal 214 that is in the liquid state in the melting apparatus 100 and supplies the molten metal 214 to the crucible 211. Therefore, the molten metal 214 that is of a fixed amount and at a fixed temperature can be supplied from the melting apparatus 100 to the crucible 211. Consequently, because the temperature-raising heating unit 212 can raise the temperature of the molten metal 214 inside the crucible 211 with a fixed amount of heating energy, equipment cost can be reduced compared to when the heating energy applied to the crucible 211 is individually output-controlled. In addition, because the amount and the temperature of the molten metal 214 inside the crucible 211 are fixed, the steps of the cleaning process can be shared and the degree of purity of the molten metal 214 can be kept consistent. Therefore, the system can supply the molten metal 214 that is high in quality in terms of having a target fixed amount, a target fixed temperature, and target fixed purity to the external processing equipment 400 from the crucible 211 through the molten metal supply apparatus 300. Consequently, variations in quality such as changes in dimensional accuracy and internal quality, and presence/absence of flash formation can be reduced in cast products processed by the external processing equipment 400. A lean processing design can be actualized with regard to production design taking into consideration defect rates, post-processing finishing, and the like.

Furthermore, the system produces the molten metal 214 at a required amount at a required time in the melting apparatus 100, raises the temperature of the molten metal 211 in the crucible 211 and supplies the molten metal 214 to the external processing equipment 400, without requiring a large amount of molten metal 214 to be held while being heat-retained at all times. Consequently, the system can contribute to carbon neutrality and further contribute to safety at a manufacturing site.

(2) The melting apparatus 100 provided in the present system has the induction heating unit that heats the metal material 101 by electromagnetic induction, and is configured to change the metal material 101 that is in a solid state to the molten metal 214 and directly supply the molten metal 214 to the crucible 211. The control apparatus 500 is configured to control a melting speed of the metal material 101 by adjusting output of the induction heating unit and adjust the amount of molten metal 214 produced by the melting apparatus 100.

As a result, the melting speed of the metal material 101 is controlled by the output of the induction heating unit being adjusted, and the molten metal 214 is directly supplied from the melting apparatus 100 to the crucible 211 while the metal material 101 in the solid state is changed to the molten metal 214. Consequently, the molten metal 214 can be supplied to the crucible at a required amount at a required time at a temperature near the melting point immediately after melting (that is, a fixed temperature with little variation), without the molten metal 214 being held in the melting apparatus 100.

(3) The melting apparatus 100 has the molten-metal amount detecting unit that detects the amount of molten metal 214 housed in the crucible 211. The control apparatus 500 is configured to adjust the amount of molten metal 214 produced by the melting apparatus 100 based on the amount of molten metal 214 detected by the molten-metal amount detecting unit.

Consequently, the molten metal 214 can be supplied from the melting apparatus 100 to the crucible 211 at a target fixed amount and a target fixed temperature with little variation. Here, the molten-metal amount detecting unit is not limited to the molten-metal surface detecting unit 106 given as an example according to the embodiment. For example, various sensors such as a load sensor or a contact sensor can be used.

(4) For example, the molten-metal amount detecting unit is the molten-metal surface detecting unit 106 that detects the molten-metal surface height of the molten metal 214 housed in the crucible 211. The control apparatus 500 is configured to control the melting speed of the metal material 101 by adjusting the output of the induction heating unit based on the molten-metal surface height of the molten metal 214 detected by the molten-metal surface detecting unit 106, and adjust the amount of the molten metal 214 produced by the melting apparatus 100.

Consequently, the molten metal 214 can be supplied at a target amount and a target temperature with little variation from the melting apparatus 100 to the crucible 211.

(5) The temperature-raising heating unit 212 provided in the temperature raising apparatus 200 of the present system is configured to heat the molten metal 214 housed in the crucible 211 with a fixed amount of heating energy.

Consequently, because the molten metal 214 is supplied at a fixed amount and a fixed temperature from the melting apparatus 100 to the crucible 211, the molten metal 214 of which the temperature is raised to a target fixed temperature with little variation can be produced by the temperature-raising heating unit 212 heating the molten metal 214 with the fixed amount of heating energy. In addition, because a heating energy adjustment function is not required in the temperature-raising heating unit 212, equipment cost can be reduced.

(6) The temperature raising apparatus 200 of the present system has a plurality of crucibles 211 and a plurality of temperature-raising heating units 212 that are respectively provided in the plurality of crucibles 211.

Here, when the induction-heating temperature-raising heating unit 212 is set on a stand on which the plurality of crucibles 211 are set, if the plurality of crucibles 211 are no longer heated while the crucibles 211 move between stations, a heating output design that takes into account temperature decrease between stations is required. In addition, this leads to increase in temperature variation in the molten metal 214 from when the temperature is raised until the molten metal 214 is supplied.

In this regard, the temperature raising apparatus 200 of the present system provides the plurality of temperature-raising heating units 212 in the plurality of crucibles 211. Therefore, the plurality of crucibles 211 are continuously heated even while the crucibles 211 move between stations, and temperature variation in the molten metal 214 can be reduced.

(7) The temperature raising apparatus 200 of the present system includes the cleaning ST that performs the cleaning process by a fixed operation on the molten metal 214 supplied to the crucible 211.

Consequently, because the amount and the temperature of the molten metal 214 inside the crucible 211 are fixed, the steps of the cleaning process can be shared and the degree of purity can be maintained at a consistently high quality.

(8) At the cleaning ST, the gas pipe 221 that supplies inert gas 222 to the molten metal 214 from an arbitrary position between the center in the depth direction of the molten metal 214 supplied to the crucible 211 and the bottom of the crucible 211 is provided.

Consequently, as a result of the inert gas 222 being supplied to the molten metal 214 from near the bottom of the crucible 211, production of oxides in the molten metal 214 can be reduced.

(9) The molten metal supply apparatus 300 of the present system has the molten metal supply pot 311 to which the molten metal 214 from the crucible 211 is removed and held, and the weight measuring unit 319 that measures the weight of the molten metal supply pot 311 in three axial directions of the orthogonal coordinate system set in the molten metal supply pot 311. The control apparatus 500 calculates the amount of molten metal 214 removed from the crucible 211 to the molten metal supply pot 311 based on the difference between the weight of the molten metal supply pot 311 measured by the weight measuring unit 319 before the molten metal 214 is removed from the crucible 211 to the molten metal supply pot 311 and the weight of the molten metal supply pot 311 measured by the weight measuring unit 311 after the molten metal 214 is removed from the crucible 211 to the molten metal supply pot 311.

As a result, because the amount of molten metal 214 removed from the crucible 211 to the molten metal supply pot 311 is calculated by the difference in weight of the molten metal supply pot 311, even when metal residue remains in the bottom of the molten metal supply pot 311 due to bonding or the like, the target amount of molten metal 214 can be removed from the crucible 211 to the molten metal supply pot 311. Consequently, the molten metal supply apparatus 300 can supply the target amount of molten metal 214 from the molten metal supply pot 311 to the external processing equipment 400.

Furthermore, the control apparatus 500 uses the weight measuring unit 319 to measure the weight of the molten metal supply pot 311 in three axial directions. Therefore, even when the molten metal supply apparatus 300 is tilted in relation to the vertical direction, the target amount of molten metal 214 can be removed from the crucible 211 to the molten metal supply pot 311. Consequently, the molten metal supply apparatus 300 can supply the target amount of molten metal 214 from the molten metal supply pot 311 to the external processing equipment 400.

(10) The control apparatus 500 of the present system is configured to suction the required amount of molten metal 214 from the crucible 214 to the molten metal supply pot 311 while continuously measuring the weight of the molten metal supply pot 311 by the weight measuring unit 319 when the molten metal 214 is suctioned from the crucible 211 to the molten metal supply pot 311.

As a result, because the control apparatus 500 suctions the required amount of molten metal 214 while continuously measuring the weight of the molten metal supply pot 311 when the molten metal 214 is suctioned from the crucible 211 to the molten metal supply pot 311, the target amount of molten metal 214 can be removed from the crucible 211 to the molten metal supply pot 311. Consequently, the molten metal supply apparatus 300 can supply the target amount of molten metal 214 from the molten metal supply pot 311 to the external processing equipment 400.

Here, as described above, the control apparatus 500 continuously measures the weight of the molten metal supply pot 311 before the molten metal 214 is removed from the crucible 211 to the molten metal supply pot 311 and after the molten metal 214 is removed from the crucible 211 to the molten metal supply pot 311, and calculates the amount of molten metal 214 removed from the crucible 211 to the molten metal supply pot 311 based on the difference in weight. Consequently, the molten metal supply apparatus 300 can supply a more accurate amount of molten metal 214 from the molten metal supply pot 311 to the external processing equipment 400.

(11) The molten metal supply apparatus 300 of the present system has the molten-metal temperature detecting unit 315 that detects the temperature of the molten metal 214 held in the molten metal supply pot 311 and the molten metal supply heating unit 316 that heats the molten metal 214 held in the molten metal supply pot 311. The control apparatus 500 is configured to adjust energy with which the molten metal 214 is heated by the molten metal supply heating unit 316 based on the temperature of the molten metal 214 detected by the molten-metal temperature detecting unit 315.

Consequently, the molten metal supply apparatus 300 can supply the molten metal 214 to the external processing equipment 400 at a fixed temperature while reliably maintaining the temperature of the molten metal 214 heated by the temperature raising apparatus 200.

(12) The molten metal supply apparatus 300 of the present system has the thermal insulation wall 317 provided on the outer side the molten metal supply pot 311. The thermal insulation wall 317 is composed of a material that has lower thermal conductivity than the molten metal supply pot 311 and is capable of suppressing heat dissipation of the molten metal 214 held in the molten metal supply pot 311.

Consequently, the molten metal supply apparatus 300 can supply the molten metal 214 to the external processing equipment 400 at a fixed temperature while reliably maintaining the temperature of the molten metal 214 heated by the temperature raising apparatus 200. In addition, the energy with which the molten metal 214 is heated by the molten metal supply heating unit 316 can be reduced.

(13) The bottom inner wall 321 of the molten metal supply pot 311 has a tapered shape at an angle exceeding 0° in relation to a virtual plane perpendicular to the axis CL of the molten metal supply pot 311.

As a result, even when the molten metal supply pot 311 tilts in relation to the vertical direction when the molten metal 214 is supplied from the molten metal supply apparatus 300 to the external processing equipment 400, residue of the molten metal 214 attaching to the bottom inner wall 321 of the molten metal supply pot 311 can be reduced. Consequently, a more accurate amount of molten metal 214 can be supplied from the molten metal supply apparatus 300 to the external processing equipment 400.

### Other Embodiments

The present disclosure is not limited to the above-described embodiments and can be modified as appropriate within the scope recited in the scope of claims. In addition, the above-described embodiments and portions thereof are not unrelated to each other and can be combined as appropriate unless combination is clearly not possible. Furthermore, according to the above-described embodiments, it goes without saying that an element that configures an above-described embodiment is not necessarily a requisite unless particularly specified as being a requisite, clearly considered a requisite in principle, or the like. In addition, according to the above-described embodiments, in cases in which a numeric value, such as quantity, numeric value, amount, or range, of a constituent element is stated, the present disclosure is not limited to the specific number unless particularly specified as being a requisite, clearly limited to the specific number in principle, or the like. Furthermore, according to the above-described embodiments, when a shape, a positional relationship, or the like of a constituent element or the like is mentioned, excluding cases in which the shape, the direction, the positional relationship, or the like is clearly described as particularly being a requisite, is clearly limited to a specific shape, positional relationship, or the like in principle, or the like, the present disclosure is not limited to the shape, positional relationship, or the like.

The control apparatus 500 and the method thereof described in the present disclosure may be actualized by a dedicated computer that is provided such as to be configured by a processor and a memory, the processor being programmed to provide one or a plurality of functions that are realized by a computer program. The control apparatus 500 and the method thereof described in the present disclosure may be actualized by a dedicated computer that is provided by a processor being configured by a single dedicated hardware logic circuit or more. The control apparatus 500 and the method thereof described in the present disclosure may be actualized by a single dedicated computer or more. The dedicated computer may be configured by a combination of a processor that is programmed to provide one or a plurality of functions, a memory, and a processor that is configured by a single hardware logic circuit or more. The computer program may be stored in a non-transitory, tangible storage medium that can be read by a computer as instructions performed by the computer. The above-described memory is the non-transitory, tangible storage medium.

### Aspects of the Present Disclosure

The present disclosure described above can, for example, be understood according to the following aspects.

### First Aspect

A metal melting and temperature-raising supply system that melts a metal material (101) that is in a solid state, raises a temperature of the metal material, and supplies the metal material to an external processing equipment (400), the metal melting and temperature-raising supply system including: a melting apparatus (100) that heats the metal material and changes the metal material to a molten metal (214) that is in a liquid state; a temperature raising apparatus (200) that includes a heat-resistant container (211) that houses the molten metal produced by the melting apparatus and a temperature-raising heating unit (212) that heats the molten metal housed in the heat-resistant container; a molten metal supply apparatus (300) that supplies the molten metal to the external processing equipment in a state in which the temperature of the molten metal heated by the temperature-raising heating apparatus is maintained; and a control apparatus (500) that controls an amount of metal material in the solid state changed to the molten metal by the melting apparatus and supplied to the heat-resistant container, based on an amount of molten metal supplied to the external processing equipment from the molten metal supply apparatus.

### Second Aspect

The metal melting and temperature-raising supply system according to the first aspect in which: the melting apparatus has an induction heating unit (102) that heats the metal material by electromagnetic induction and is configured to change the metal material to molten metal and directly supply the molten metal to the heat-resistant container; and the control apparatus is configured to control a melting speed of the metal material by adjusting output of the induction heating unit and adjust the amount of molten metal produced in the melting apparatus.

### Third Aspect

The metal melting and temperature-raising supply system according to the second aspect in which: the melting apparatus has a molten-metal amount detecting unit (106) that detects the amount of molten metal housed in the heat-resistant container; and the control apparatus is configured to control the melting speed of the metal material by adjusting the output of the induction heating unit based on the amount of molten metal detected by the molten-metal amount detecting unit, and adjust the amount of molten metal produced in the melting apparatus.

### Fourth Aspect

The metal melting and temperature-raising supply system according to the third aspect in which: the molten-metal amount detecting unit is a molten-metal surface detecting unit (106) that detects a molten-metal surface height of the molten metal housed in the heat-resistant container; and the control apparatus is configured to control the melting speed of the metal material by adjusting the output of the induction heating unit based on the molten-metal surface height of the molten metal detected by the molten-metal surface detecting unit, and adjust the amount of molten metal produced in the melting apparatus.

### Fifth Aspect

The metal melting and temperature-raising supply system according to any one of the first to fourth aspects in which: the temperature-raising heating unit is configured to heat the molten metal housed in the heat-resistant container with a fixed amount of heating energy.

### Sixth Aspect

The metal melting and temperature-raising supply system according to any one of the first to fifth aspects, in which: the temperature raising apparatus has a plurality of heat-resistant containers and a plurality of temperature-raising heating units respectively provided in the plurality of heat-resistant containers.

### Seventh Aspect

The metal melting and temperature-raising supply system according to any one of the first to sixth aspects, in which: the temperature raising apparatus has a cleaning processing unit that performs a cleaning process by fixed operations on the molten metal supplied to the heat-resistant container.

### Eighth Aspect

The metal melting and temperature-raising supply system according to the seventh aspect, in which: the cleaning processing unit is provided with a gas pipe (221) that supplies inert gas (222) to the molten metal from an arbitrary position between a center in a depth direction of the molten metal supplied to the heat-resistant container and a bottom inner wall of the heat-resistant container.

### Ninth Aspect

The metal melting and temperature-raising supply system according to any one of the first to eighth aspects, in which: the molten metal supply apparatus has a molten metal supply container (311) to which the molten metal is removed from the heat-resistant container and held in a sealed space, and a weight measuring unit (319) that measures weight of the molten metal supply container in three axial directions in an orthogonal coordinate system set in the molten metal supply container; and the control apparatus calculates an amount of molten metal removed from the heat-resistant container to the molten metal supply container based on the weight of the molten metal supply container measured by the weight measuring unit before the molten metal is removed from the heat-resistant container to the molten metal supply container and the weight of the molten metal supply container measured by the weight measuring unit after the molten metal is removed from the heat-resistant container to the molten metal supply container.

### Tenth Aspect

The metal melting and temperature-raising supply system according to the ninth aspect, in which: the control apparatus is configured to suction the molten metal at a required amount from the heat-resistant container to the molten metal supply container while continuously measuring the weight of the molten metal supply container by the weight measuring unit when the molten metal is suctioned from the heat-resistant container to the molten metal supply container.

### Eleventh Aspect

The metal melting and temperature-raising supply system according to the ninth or tenth aspect, in which: the molten metal supply apparatus has a molten-metal temperature detecting unit (315) that detects a temperature of the molten metal held in the molten metal supply container and a molten metal supply heating unit (316) that heats the molten metal held in the molten metal supply container; and the control apparatus is configured to adjust energy with which the molten metal is heated in the molten metal supply heating unit based on the temperature of the molten metal detected by the molten-metal temperature detecting unit.

### Twelfth Aspect

The metal melting and temperature-raising supply system according to any one of the ninth to eleventh aspects, in which: the molten metal supply apparatus has a thermal insulation wall (317) provided on an outer side of the molten metal supply container, the thermal insulation wall is composed of a material having lower thermal conductivity than the molten metal supply container, whereby heat dissipation of the molten metal held in the molten metal supply container can be suppressed.

### Thirteenth Aspect

The metal melting and temperature-raising supply system according to any one of the ninth to twelfth aspects, in which: a bottom inner wall (321) of the molten metal supply container has a tapered shape at an angle exceeding 0° in relation to a virtual plane perpendicular to an axis (CL) of the molten metal supply container.

### Fourteenth Aspect

A molten metal supply apparatus (300) that supplies a molten metal (214) obtained by melting a metal material (101) to an external processing equipment (400), the molten metal supply apparatus including: a molten metal supply container (311) to which the molten metal is removed from a heat-resistant container (211) that houses the molten metal, and held in a sealed space; a weight measuring unit (319) that measures weight of the molten metal supply container in three axial directions in an orthogonal coordinate system set in the molten metal supply container, and a control apparatus (500) that calculates an amount of molten metal removed from the heat-resistant container to the molten metal supply container, based on a difference between the weight of the molten metal supply container measured by the weight measuring unit before the molten metal is removed from the heat-resistant container to the molten metal supply container and the weight of the molten metal supply container measured by the weight measuring unit after the molten metal is removed from the heat-resistant container to the molten metal supply container.

Here, the fourteenth aspect can be arbitrarily combined with the contents according to the tenth to thirteenth aspects.

1. A metal melting and temperature-raising supply system that melts a metal material that is in a solid state, raises a temperature of the metal material, and supplies the metal material to an external processing equipment, the metal melting and temperature-raising supply system comprising:
a melting apparatus that heats the metal material and changes the metal material to a molten metal that is in a liquid state;
a temperature raising apparatus that includes a heat-resistant container that houses the molten metal produced by the melting apparatus and a temperature-raising heating unit that heats the molten metal housed in the heat-resistant container;
a molten metal supply apparatus that supplies the molten metal to the external processing equipment in a state in which the temperature of the molten metal heated by the temperature-raising heating apparatus is maintained; and
a control apparatus that controls an amount of metal material in the solid state changed to the molten metal by the melting apparatus and supplied to the heat-resistant container, based on an amount of molten metal supplied to the external processing equipment from the molten metal supply apparatus.

2. The metal melting and temperature-raising supply system according to claim 1, wherein:
the melting apparatus has an induction heating unit that heats the metal material by electromagnetic induction and is configured to change the metal material to molten metal and directly supply the molten metal to the heat-resistant container; and
the control apparatus is configured to control a melting speed of the metal material by adjusting output of the induction heating unit and adjust the amount of molten metal produced in the melting apparatus.

3. The metal melting and temperature-raising supply system according to claim 2, wherein:
the melting apparatus has a molten-metal amount detecting unit that detects the amount of molten metal housed in the heat-resistant container; and
the control apparatus is configured to control the melting speed of the metal material by adjusting the output of the induction heating unit based on the amount of molten metal detected by the molten-metal amount detecting unit, and adjust the amount of molten metal produced in the melting apparatus.

4. The metal melting and temperature-raising supply system according to claim 3, wherein:
the molten-metal amount detecting unit is a molten-metal surface detecting unit that detects a molten-metal surface height of the molten metal housed in the heat-resistant container; and
the control apparatus is configured to control the melting speed of the metal material by adjusting the output of the induction heating unit based on the molten-metal surface height of the molten metal detected by the molten-metal surface detecting unit, and adjust the amount of molten metal produced in the melting apparatus.

5. The metal melting and temperature-raising supply system according to claim 1, wherein:
the temperature-raising heating unit is configured to heat the molten metal housed in the heat-resistant container with a fixed amount of heating energy.

6. The metal melting and temperature-raising supply system according to claim 1, wherein:
the temperature raising apparatus has a plurality of heat-resistant containers and a plurality of temperature-raising heating units respectively provided in the plurality of heat-resistant containers.

7. The metal melting and temperature-raising supply system according to claim 1, wherein:
the temperature raising apparatus has a cleaning processing unit that performs a cleaning process by fixed operations on the molten metal supplied to the heat-resistant container.

8. The metal melting and temperature-raising supply system according to claim 7, in which:
the cleaning processing unit is provided with a gas pipe that supplies inert gas to the molten metal from an arbitrary position between a center in a depth direction of the molten metal supplied to the heat-resistant container and a bottom inner wall of the heat-resistant container.

9. The metal melting and temperature-raising supply system according to claim 1, wherein:
the molten metal supply apparatus has a molten metal supply container o which the molten metal is removed from the heat-resistant container and held in a sealed space, and a weight measuring unit that measures weight of the molten metal supply container in three axial directions in an orthogonal coordinate system set in the molten metal supply container; and
the control apparatus calculates an amount of molten metal removed from the heat-resistant container to the molten metal supply container based on the weight of the molten metal supply container measured by the weight measuring unit before the molten metal is removed from the heat-resistant container to the molten metal supply container and the weight of the molten metal supply container measured by the weight measuring unit after the molten metal is removed from the heat-resistant container to the molten metal supply container.

10. The metal melting and temperature-raising supply system according to claim 9, wherein:
the control apparatus is configured to suction the molten metal at a required amount from the heat-resistant container to the molten metal supply container while continuously measuring the weight of the molten metal supply container by the weight measuring unit when the molten metal is suctioned from the heat-resistant container to the molten metal supply container.

11. The metal melting and temperature-raising supply system according to claim 9, wherein:
the molten metal supply apparatus has a molten-metal temperature detecting unit that detects a temperature of the molten metal held in the molten metal supply container and a molten metal supply heating unit that heats the molten metal held in the molten metal supply container; and
the control apparatus is configured to adjust energy with which the molten metal is heated in the molten metal supply heating unit based on the temperature of the molten metal detected by the molten-metal temperature detecting unit.

12. The metal melting and temperature-raising supply system according to claim 9, wherein:
the molten metal supply apparatus has a thermal insulation wall provided on an outer side of the molten metal supply container, and
the thermal insulation wall is composed of a material having lower thermal conductivity than the molten metal supply container, whereby heat dissipation of the molten metal held in the molten metal supply container can be suppressed.

13. The metal melting and temperature-raising supply system according to claim 9, wherein:
a bottom inner wall of the molten metal supply container has a tapered shape at an angle exceeding 0° in relation to a virtual plane perpendicular to an axis of the molten metal supply container.

14. A molten metal supply apparatus that supplies a molten metal obtained by melting a metal material to an external processing equipment, the molten metal supply apparatus comprising:
a molten metal supply container to which the molten metal is removed from a heat-resistant container that houses the molten metal, and held in a sealed space;
a weight measuring unit that measures weight of the molten metal supply container, and
a control apparatus that calculates an amount of molten metal removed from the heat-resistant container to the molten metal supply container, based on a difference between the weight of the molten metal supply container measured by the weight measuring unit before the molten metal is removed from the heat-resistant container to the molten metal supply container and the weight of the molten metal supply container measured by the weight measuring unit after the molten metal is removed from the heat-resistant container to the molten metal supply container.

15. The metal melting and temperature-raising supply system according to claim 9, wherein:
the weight measuring unit measures weight of the molten metal supply container in three axial directions in an orthogonal coordinate system set in the molten metal supply container.

16. The molten metal supply apparatus according to claim 14, wherein:
the weight measuring unit measures weight of the molten metal supply container in three axial directions in an orthogonal coordinate system set in the molten metal supply container.
